(19) United States
(12) Patent Application Publication
(10) Pub. No.: US 2010/0122605 A1
(43) Pub. Date: May 20, 2010

(54) ONE PIECE PENDULUM

(75) Inventors: Stephan MAIENSCHEIN, Baden-Baden (DE); Jonathan G. JAMESON, Dalton, OH (US)

Correspondence Address: SIMPSON & SIMPSON, PLLC, 5555 MAIN STREET, WILLIAMSVILLE, NY, 14221-5406, US

(73) Assignee: LUK LAMELLEN UND KUPPLUNGSBAU BETEILIGUNGS KG, Buehl (DE)

(21) Appl. No.: 12/618,149

(22) Filed: Nov. 13, 2009

Related U.S. Application Data
(60) Provisional application No. 61/199,540, filed on Nov. 18, 2008.

(51) Int. Cl. F16F 15/14

(52) U.S. Cl. 74/574.2

(57) ABSTRACT

A pendulum for a damper, including: a first plate with a first side; a first plurality of through-slots in the first plate including respective first openings at the first side; a second plate with a second side; a second plurality of through-slots in the second plate including respective second openings at the second side; and a plurality of rollers for placement in the first and second plurality of through-slots. Respective portions of the first side reduce a dimension for the first plurality of through-slots at the first openings. Respective portions of the second side reduce a dimension for the second plurality of through-slots at the second openings. The respective portions of the first side are for restraining the rollers in a first direction and the respective portions of the second side are for restraining the rollers in a second direction, opposite the first direction.

### CROSS-REFERENCE TO RELATED APPLICATIONS

This application claims the benefit under 35 U.S.C. §119(e) of U.S. Provisional Application No. 61/199,540 on Nov. 18, 2008 which application is incorporated herein by reference.

### FIELD OF THE INVENTION

The invention relates to a pendulum and a damper with a pendulum. In particular, the invention relates to a pendulum having a maximized width.

### BACKGROUND OF THE INVENTION

Pendulums for dampers are known in the art. The known applications teach the use of separate cover plates or an exterior counter bore in a pendulum plate.

### BRIEF SUMMARY OF THE INVENTION

The present invention broadly comprises a pendulum for a damper, including: a first plate with a first side; a first plurality of through-slots in the first plate including respective first openings at the first side; a second plate with a second side; a second plurality of through-slots in the second plate including respective second openings at the second side; and a plurality of rollers for placement in the first and second plurality of through-slots. Respective portions of the first side reduce a dimension for the first plurality of through-slots at the first openings. Respective portions of the second side reduce a dimension for the second plurality of through-slots at the second openings. The respective portions of the first side are for restraining the rollers in a first direction and the respective portions of the second side are for restraining the rollers in a second direction, opposite the first direction.

In one embodiment, the first and second pluralities of through-slots include respective radially outward sides and the respective first and second portions form a portion of the radially outward sides. In one embodiment, the first and second pluralities of through-slots include respective radially inward sides and the respective first and second portions extend from the radially inward sides. In one embodiment, the first and second pluralities of through-slots include respective radially outward and inward sides and the respective first and second portions form a portion of the radially outward and inward sides. In one embodiment, the first and second pluralities of through-slots include respective radially inward sides and the respective first and second portions extend from the radially inward sides.

The present invention also broadly comprises a damper, including: a flange plate with a plurality of fastener openings and a plurality of roller openings; a first pendulum plate with a first side and a first plurality of through-slots with respective first ends reduced in size by respective first portions of the first side; a second pendulum plate with a second side and a second plurality of through-slots with respective second ends reduced in size by respective second portions of the second side; a plurality of fasteners fixedly connecting the first and second pendulum plates and passing through the plurality of fastener openings; and a plurality of rollers disposed in the plurality of roller openings and in the first and second pluralities of openings. The respective first portions are for restraining the rollers in a first axial direction and the respective second portions are for restraining the rollers in a second axial direction, opposite the first axial direction.

In one embodiment, the first and second pluralities of through-slots include respective radially outward sides and the respective first and second portions form respective portions of the radially outward sides. In one embodiment, the respective first and second portions include radial protrusions extending from only part of the radially outward sides. In one embodiment, the first and second pluralities of through-slots include respective radially inward sides and wherein the respective first and second portions form respective portions of the radially inward sides.

In one embodiment, the first and second pluralities of through-slots include respective radially outward and inward sides and the respective first and second portions form a portion of the radially outward and inward sides. In one embodiment, the respective first and second portions include lips along the radially outward and inward sides. In one embodiment, the plurality of rollers include respective first and second axial ends and the respective first portions are for restraining the rollers in a first axial direction by contacting the respective first axial ends and the respective second portions are for restraining the rollers in a second axial direction by contacting the respective second axial ends.

The present invention further broadly comprises damper, including: a flange plate with a first plurality of openings; a first pendulum plate disposed on one side of the flange plate and with a second plurality of openings and a first radial wall facing a first axial direction; a second pendulum plate disposed on another side of the flange plate and with a third plurality of openings and a second radial wall facing a second axial direction opposite the first axial direction; a plurality of fasteners connecting the first and second pendulum plates and with respective first and second longitudinal ends; and a plurality of rollers disposed in the first, second and third pluralities of openings. The respective first and second longitudinal ends are radially aligned with the first and second radial walls or axially between the first and second radial walls.

In one embodiment, the first pendulum plate includes a first plurality of through-openings with a first segment having a first diameter and with a second segment, at the first radial wall, having a second diameter greater than the first diameter and the second pendulum plate includes a second plurality of through-openings with a third segment having a third diameter and with a fourth segment, at the second radial wall, having a fourth diameter greater than the third diameter.

The present invention broadly comprises a method for dampening vibration.

It is a general object of the present invention to provide a pendulum to dampen vibration in a damper and a damper with a pendulum for dampening vibration.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a partial front view of a present invention pendulum and damper;

FIG. 2 is a cross-sectional view generally along line 2-2 in FIG. 1;

FIG. 3 is a cross-sectional view generally along line 3-3 in FIG. 1;

FIG. 4 is a partial exploded view of a present invention pendulum and damper;

FIG. 5 is a front view of the pendulum and damper shown in FIG. 4;

FIG. 6 is a cross-sectional view generally along line 6-6 in FIG. 5;

FIG. 7 is a cross-sectional view generally along line 7-7 in FIG. 5;

FIG. 8 is a detail of area 8 in FIG. 7;

FIG. 9A is a perspective view of a cylindrical coordinate system demonstrating spatial terminology used in the present application; and,

FIG. 9B is a perspective view of an object in the cylindrical coordinate system of FIG. 8A demonstrating spatial terminology used in the present application.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

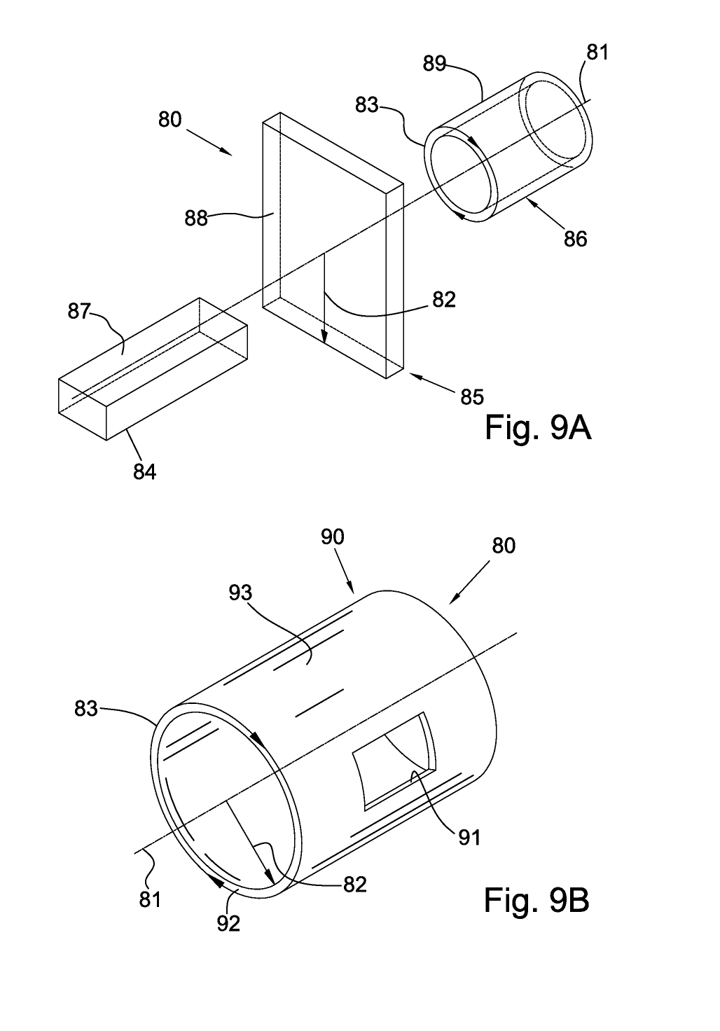

FIG. 9A is a perspective view of cylindrical coordinate system 80 demonstrating spatial terminology used in the present application. The present invention is at least partially described within the context of a cylindrical coordinate system. System 80 has a longitudinal axis 81, used as the reference for the directional and spatial terms that follow. The adjectives “axial,” “radial,” and “circumferential” are with respect to an orientation parallel to axis 81, radius 82 (which is orthogonal to axis 81), and circumference 83, respectively. The adjectives “axial,” “radial” and “circumferential” also are regarding orientation parallel to respective planes. To clarify the disposition of the various planes, objects 84, 85, and 86 are used. Surface 87 of object 84 forms an axial plane. That is, axis 81 forms a line along the surface. Surface 88 of object 85 forms a radial plane. That is, radius 82 forms a line along the surface. Surface 89 of object 86 forms a circumferential plane. That is, circumference 83 forms a line along the surface. As a further example, axial movement or disposition is parallel to axis 81, radial movement or disposition is parallel to radius 82, and circumferential movement or disposition is parallel to circumference 83. Rotation is with respect to axis 81.

The adverbs “axially,” “radially,” and “circumferentially” are with respect to an orientation parallel to axis 81, radius 82, or circumference 83, respectively. The adverbs “axially,” “radially,” and “circumferentially” also are regarding orientation parallel to respective planes.

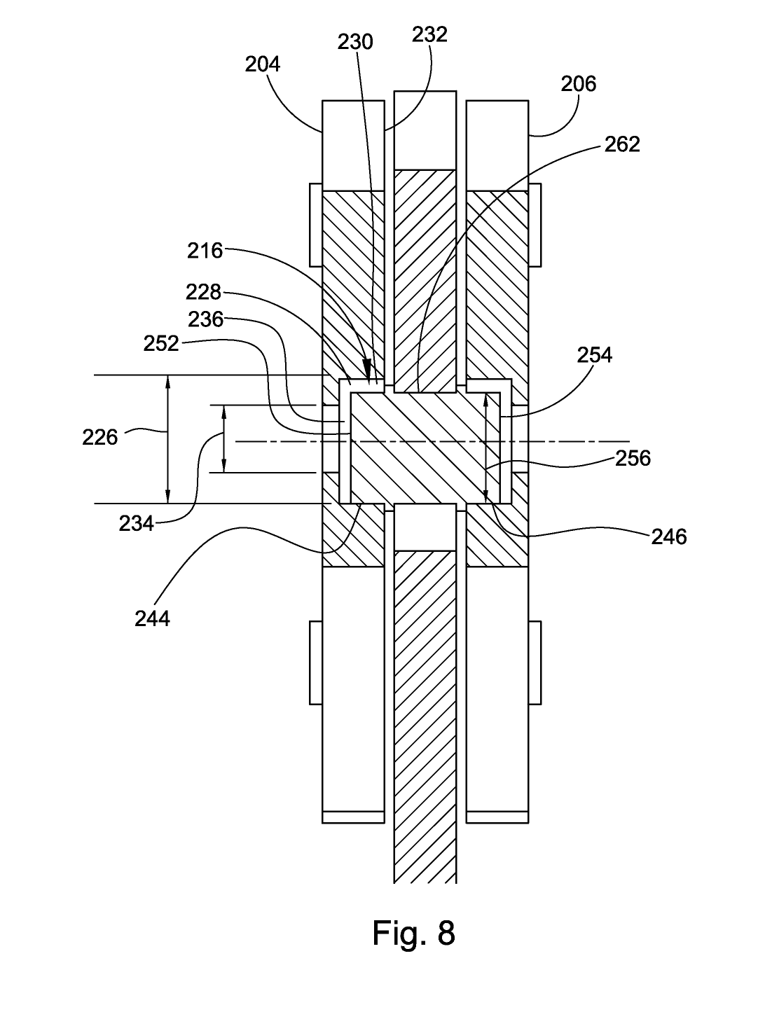

FIG. 9B is a perspective view of object 90 in cylindrical coordinate system 80 of FIG. 8A demonstrating spatial terminology used in the present application. Cylindrical object 90 is representative of a cylindrical object in a cylindrical coordinate system and is not intended to limit the present invention in any manner. Object 90 includes axial surface 91, radial surface 92, and circumferential surface 93. Surface 91 is part of an axial plane, surface 92 is part of a radial plane, and surface 93 is part of a circumferential plane.

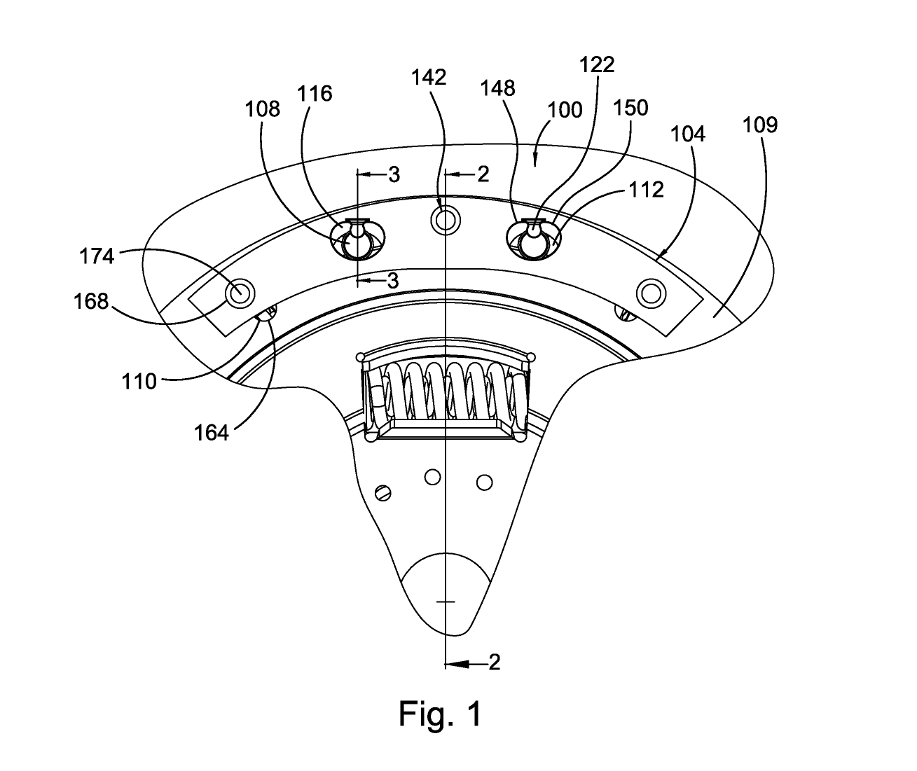

FIG. 1 is a partial front view of present invention pendulum 100.

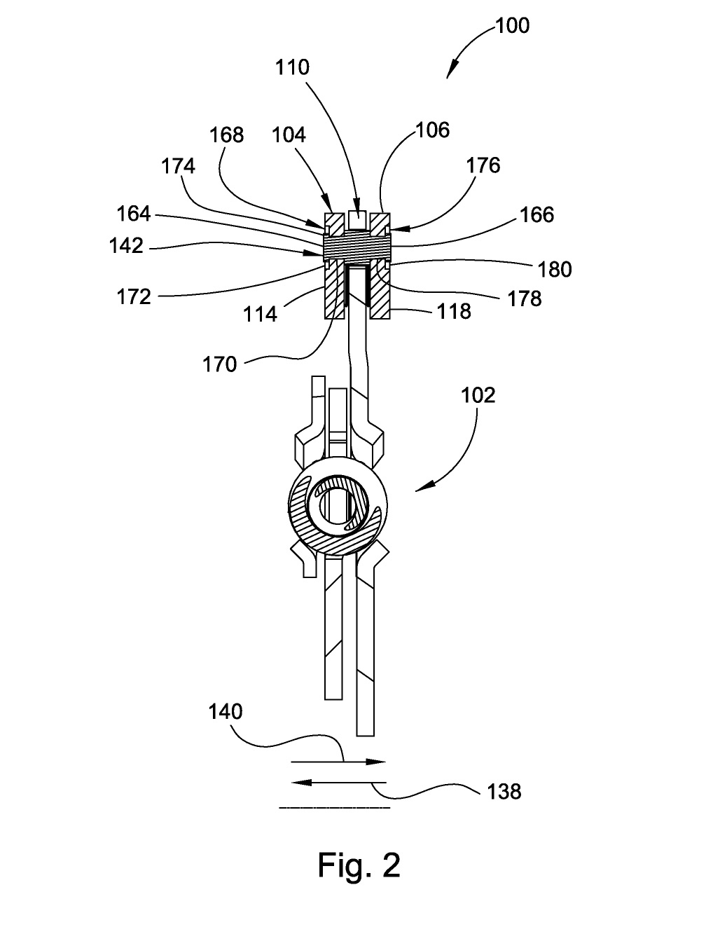

FIG. 2 is a cross-sectional view generally along line 2-2 in FIG. 1.

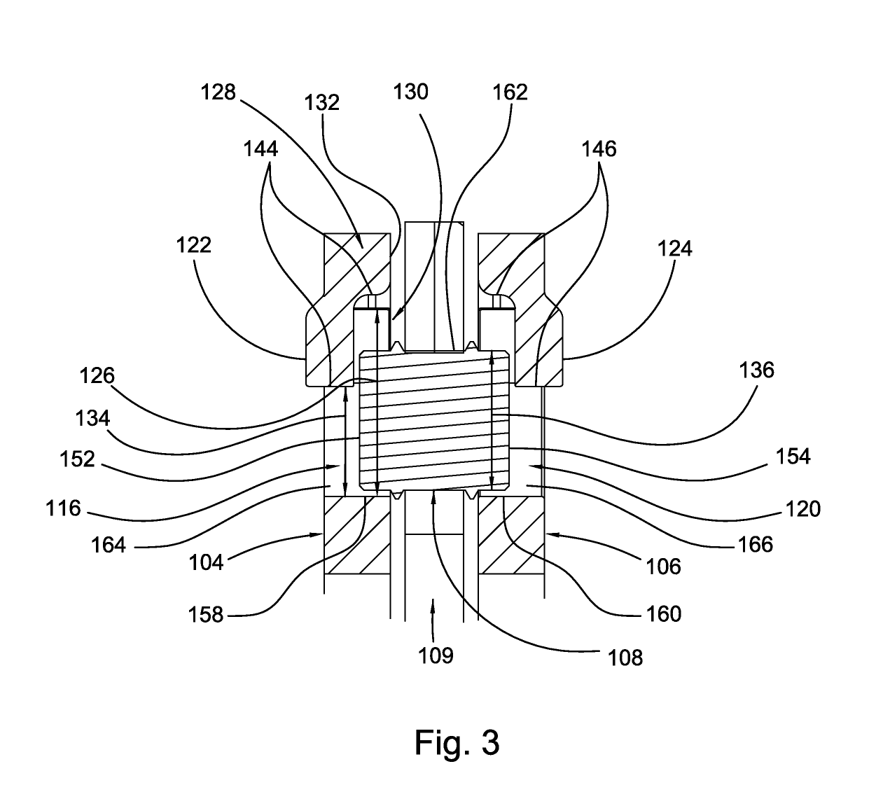

FIG. 3 is a cross-sectional view generally along line 3-3 in FIG. 1. The following should be viewed in light of FIGS. 1 through 3. Pendulum 100 is shown disposed on damper 102, and includes pendulum plates 104 and 106, and a plurality of rollers 108. Damper 102 includes flange plate 109 with a plurality of fastener openings 110 and a plurality of roller openings 112. Pendulum plate 104 includes radial side 114 and a plurality of through-slots 116. Pendulum plate 106 includes radial side 118 and a plurality of through-slots 120.

Through-slots 116 and 120 are reduced in size at ends 164 and 166, respectively, by portions 122 of side 114 and portions 124 of side 118. Alternately stated, portions 122 and 124 block respective portions of through-slots 116 and 120, a respective dimension for through-slots 116 and 118 is reduced by portions 122 and 124, or respective segments of through-slots 116 and 118 are reduced by portions 122 and 124. For example, through-slots 116 have substantially uniform radial dimensions 126 through segments 128, which extend from openings 130 at side 132 of plate 106 to portion 122. At portion 122, radial dimensions 134 are less than radial dimensions 126. That is, the size of through-slots 116 at side 114 is less than the size of openings 130. The dimensions of through-slots 116 and 118 at portions 122 and 124, respectively, or ends 164 and 166, respectively, are less than diameter 136 of the rollers, for example, dimension 134 is less than dimension 136, so that the rollers cannot pass through the openings at portions 122 and 124. The respective dimensions in the rest of through-slots 116 and 118 are larger than diameter 136 to enable movement of the rollers. For example, dimension 126 is greater than diameter 136.

Portions 122 are for restraining the rollers in axial direction 138 and portions 124 are for restraining the rollers in axial direction 140, opposite direction 138. The pendulum also includes a plurality of fasteners 142 fixedly connecting the pendulum plates and passing through openings 110.

Through-slots 116 and 120 include radially outward sides 144 and 146, respectively and portions 122 and 124 form respective portions of sides 144 and 146. For example, portions 122 extend radially inward at through-slots 116. In one embodiment, portions 122 and 124 are in the form of radial protrusions extending from only part of the radially outward sides. For example, portions 122 are in the shape of tongues and segments 148 and 150 of sides 144 are not part of the tongue.

Rollers 108 include respective axial ends 152 and 154. Portions 122 are for restraining the rollers in axial direction 138 by contacting ends 152 and portions 124 are for restraining the rollers in axial direction 142 by contacting ends 154. For example, radial dimension 134 is selected with respect to dimension 126 and diameter 136 of the rollers such that the rollers cannot pass through through-slots 116 at portion 122.

In one embodiment, when the damper is in use and the flange is rotating at operational levels for the damper, a prescribed displacement of the pendulum plates, with respect to the flange plate, occurs. For example, the centrifugal force associated with rotation of the flange causes the pendulum plates to displace radially outward until sides 158 and 160 of through-slots 116 and 118, respectively, contact the rollers. The same force causes the rollers to displace radially outward until the rollers contact sides 162 of the roller slots in the flange. The pendulum plates displace with respect to the flange plate along a path prescribed by the movement of the rollers along sides 158, 160, and 162. In one embodiment, as the pendulum plate displaces with respect to the flange plate, fasteners 142 do not contact the sides of the fastener slots in the flange plate. However, the fasteners can contact ends of the fastener slots, for example, end 164, to act as stops. That is, the movement of the pendulum plates is stopped when the fasteners contact the ends of the fastener slots.

Plurality of fasteners 142 include respective longitudinal ends 164 and 166. In one embodiment, one or both of ends 164 and 166 are radially aligned with radial sides, or walls, 114 and 118, respectively, or are axially between walls 114 and 118. That is, ends 164 and 166 do not extend axially beyond walls 114 and 118. For example, plate 104 includes a plurality of through-openings 168 with segments 170 and 172. Segments 172 are at wall 114. The diameter for segment 172 greater than the diameter for segment 170. That is, segment 172 is a counter-bore in which head 174 of fastener 142 is disposed. Similarly, plate 106 includes a plurality of through-openings 176 with segments 178 and 180. Segments 180 are at wall 118. The diameter for segment 180 is greater than the diameter for segment 178.

In one embodiment, the pendulum plates are formed by a stamping process. In one embodiment, portions 122 and 124 are coined during the stamping process. Advantageously, pendulum plates 104 and 106 are multi-functional at least because the plates provide the mass needed for a dampening affect, house the rollers, and provide axial restraint for the rollers. For example, additional components are not needed to restrain the rollers. The mass of the pendulum plates can be easily modified by changing the thickness of the plates, without affecting the outline shape of the plates.

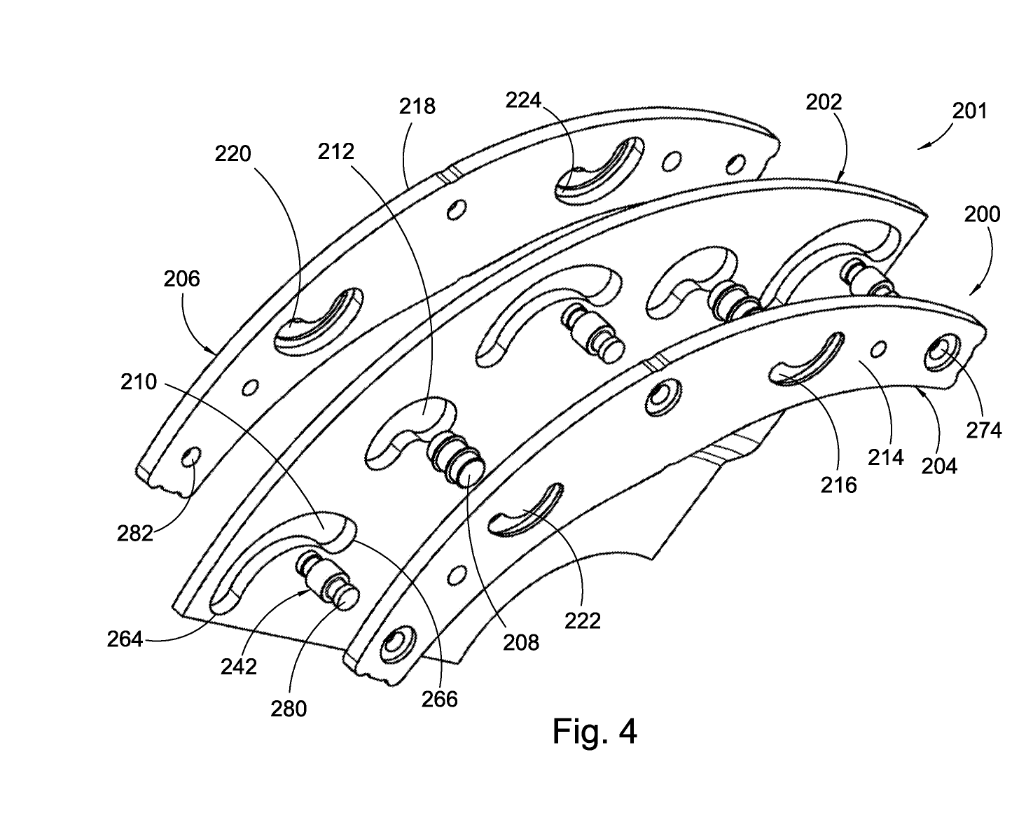

FIG. 4 is a partial exploded view of present invention pendulum 200 and damper 201.

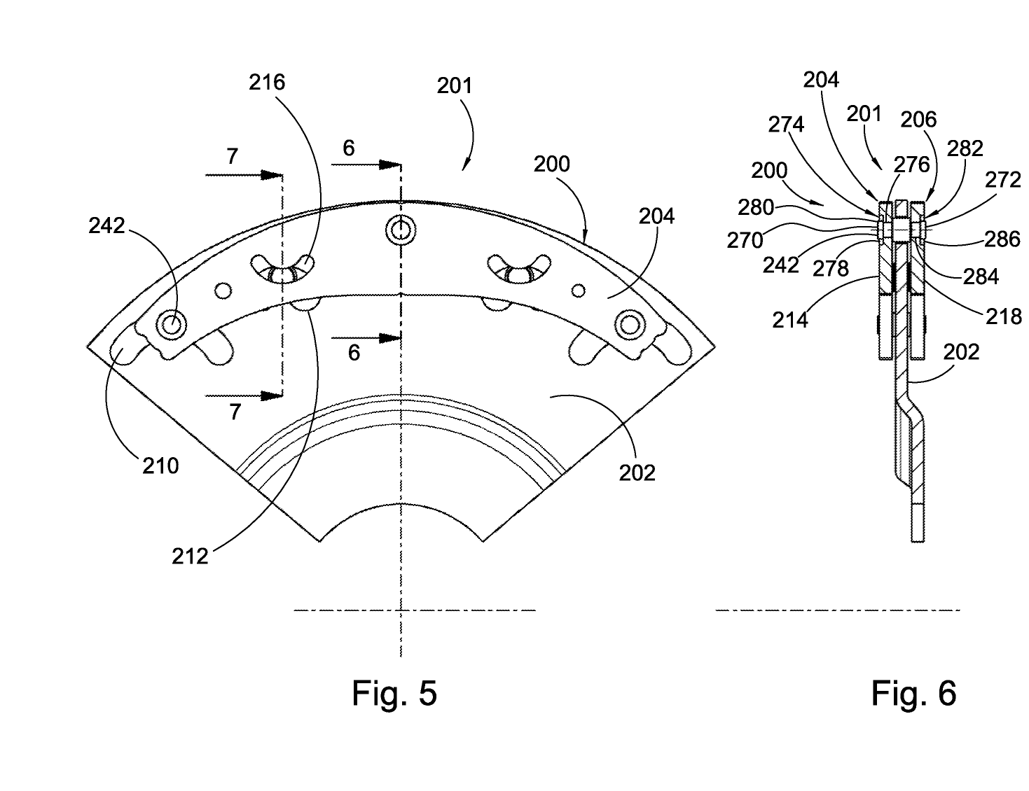

FIG. 5 is a front view of the pendulum and damper shown in FIG. 4.

FIG. 6 is a cross-sectional view generally along line 6-6 in FIG. 4.

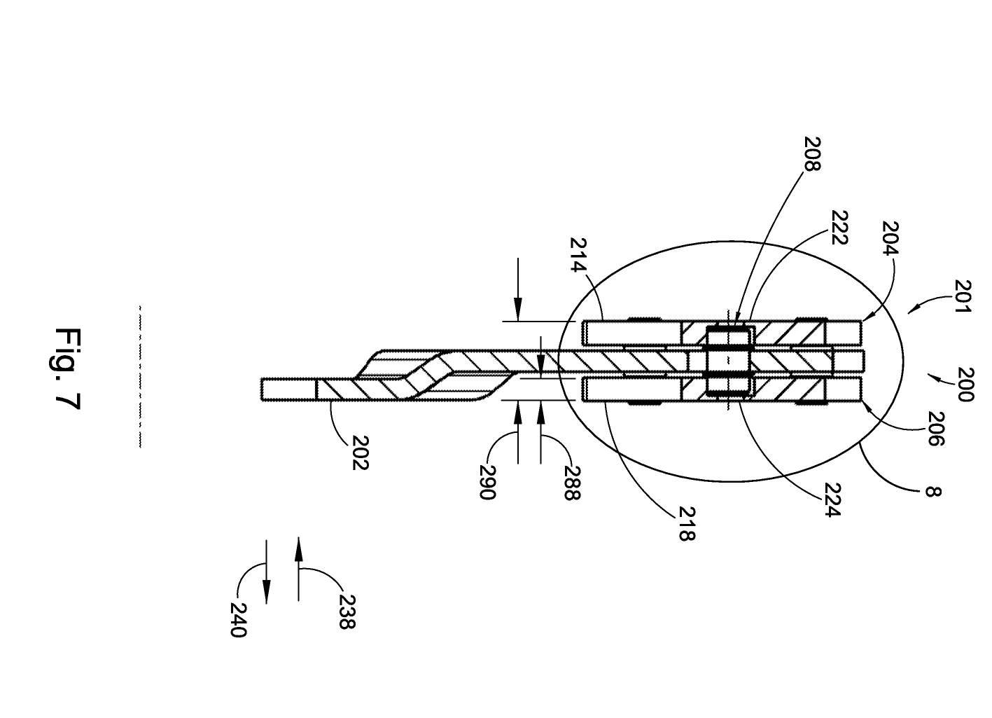

FIG. 7 is a cross-sectional view generally along line 7-7 in FIG. 4.

FIG. 8 is a detail of area 8 in FIG. 7. The following should be viewed in light of FIGS. 4 through 8. Pendulum 200 is disposed on damper 201. The damper includes flange plate 202 and the pendulum includes pendulum plates 204 and 206, and a plurality of rollers 208. The flange plate includes a plurality of fastener openings 210 and a plurality of roller openings 212. Pendulum plate 204 includes radial side 214 and a plurality of openings 216. Pendulum plate 206 includes radial side 218 and a plurality of openings 220. Openings 216 and 220 are reduced in size, respectively, by portions 222 of side 214 and portions 224 of side 218. Alternately stated, portions 222 and 224 block respective portions of openings 216 and 220. For example, openings 216 have substantially uniform radial dimensions 226 through segments 228, which extend from openings 230 at side 232 of plate 204 to portion 222. At portion 222, radial dimensions 234 are less than radial dimensions 226. That is, the size of openings 236 at side 214 is less than the size of openings 230.

Portions 222 are for restraining the rollers in axial direction 238 and portions 224 are for restraining the rollers in axial direction 240, opposite direction 238. The damper also includes a plurality of fasteners 242 fixedly connecting the pendulum plates and passing through openings 210.

Openings 216 and 220 include radially inward sides 244 and 246, respectively and portions 222 and 224 form respective portions of sides 244 and 246. For example, portions 222 extend radially towards opening 236. In one embodiment, portions 222 and 224 are in the form of lips or ridges.

Rollers 208 include respective axial ends 252 and 254. Portions 222 are for restraining the rollers in axial direction 238 by contacting ends 252 and portions 224 are for restraining the rollers in axial direction 240 by contacting ends 254. For example, radial dimension 234 is selected with respect to dimension 226 and diameter 256 of the rollers such that the rollers cannot pass through opening 230.

In one embodiment, when the damper is in use and the flange is rotating at operational levels for the damper, a prescribed displacement of the pendulum plates, with respect to the flange plate, occurs. For example, the centrifugal force associated with rotation of the flange causes the pendulum plates to displace radially outward until sides 244 and 246 of openings 216 and 220, respectively, contact the rollers. The same force causes the rollers to displace radially outward until the rollers contact sides 262 of the roller slots in the flange. The pendulum plates displace with respect to the flange plate along a path prescribed by the movement of the rollers along sides 244, 246, and 262. In one embodiment, as the pendulum plate displaces with respect to the flange plate, the fasteners do not contact the sides of the fastener slots in the flange plate. However, the fasteners can contact ends 264 and 266 of the fastener slots to act as stops.

Plurality of fasteners 242 include respective longitudinal ends 270 and 272. In one embodiment, one or both of ends 270 and 272 are radially aligned with radial sides, or walls, 214 and 218, respectively, or are axially between walls 214 and 218. That is, ends 270 and 272 do not extend axially beyond walls 214 and 218. For example, plate 204 includes a plurality of through-openings 274 with segments 276 and 278. Segments 278 are at wall 214. The diameter for segment 278 is greater than the diameter for segment 276. That is, segment 278 is a counter-bore in which head 280 of fastener 242 is disposed. Similarly, plate 206 includes a plurality of through-openings 282 with segments 284 and 286. Segments 286 are at wall 218. The diameter for segment 286 greater than the diameter for segment 284.

In one embodiment, the pendulum plates are formed by a stamping process. In one embodiment, segments 228 are coined during the stamping process. Advantageously, pendulum plates 204 and 206 are multi-functional at least because the plates provide the mass needed for a dampening affect, house the rollers, and provide axial restraint for the rollers. For example, additional components are not needed to restrain the rollers. The mass of the pendulum plates can be easily modified by changing the thickness of the plates, without affecting the outline shape of the plates.

The following should be viewed in light of FIGS. 1 through 8. Advantageously, the respective configurations of pendulum plates 104 and 106 and 204 and 206, enhance the capacity, performance, and durability of pendulums 100 and 200 by enabling a maximization of the axial widths of the plates, for example, width 288 of plate 206. For example, by maximizing the width of the pendulum plates, the weight and inertia of the plates is maximized, which optimizes the dampening function of the plates. For example, the counter-boring of the pendulum plates to accommodate the heads of fasteners 242 enables the maximization of the widths of the pendulum plates.

Advantageously, by recessing the fastener head in the respective pendulum plates, that is, not having the heads extend axially beyond the plates, the respective widths of the pendulum plates, for example, width 288 of plate 204 can be optimized within a fixed overall dimension 290 for the pendulum. For example, the axial dimension for the heads is accommodated within the width of walls 214 and 218 and does not impact dimension 290. Further, since the width of the pendulum plates is maximized, pendulums 100 and 200 advantageously maximize the axial extent of the rollers and the surface area of the pendulum plates in contact with the rollers, for example, segment 244 of plate 204. The increase in the roller size and contact area between the rollers and the pendulum plates increases the capacity and durability of the pendulums.

Although dampers 100 and 200 are shown with specific numbers, sizes, and configurations of parts, it should be under stood that a present invention damper is not limited to the specific numbers, sizes, and configurations of parts shown and that other numbers, sizes, and configurations of parts are included in the spirit and scope of the claimed invention.

The following describes a present invention method for dampening vibration. Although the method is presented as a sequence of steps for clarity, no order should be inferred from the sequence unless explicitly stated. A first step passes a plurality of fasteners through respective fastener slots in a flange plate for a damper; a second step disposes a plurality of rollers in respective roller slots in the flange plate and in first and second pendulum plates; a third step fixedly connects the first and second pendulum plates with the plurality of fasteners; a fourth step axially retains the rollers with protrusions on the first and second pendulum plates extending across a portion of the respective roller slots for the first and second pendulum plates; and in response to rotation of the flange plate, a fifth step displaces the first and second pendulum plates along a path prescribed by contact between the plurality of rollers and the flange plate.

In one embodiment, the respective roller slots for the first and second pendulum plates include respective radially outward sides and the protrusions on the first and second pendulum plates form respective portions of the radially outward sides. In one embodiment, the respective roller slots for the first and second pendulum plates include respective radially inward sides and the protrusions on the first and second pendulum plates form respective portions of the radially inward sides.

In one embodiment, the plurality of rollers include respective first and second axial ends and axially retaining the rollers with protrusions includes restraining the rollers in a first axial direction by contacting the protrusions on the first pendulum plate with the respective first axial ends, and restraining the rollers in a second axial direction by contacting the protrusions on the second pendulum plate with the respective second axial ends.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What we claim is:

1. A pendulum for a damper, comprising:
a first plate with a first side;
a first plurality of through-slots in the first plate including respective first openings at the first side, wherein respective portions of the first side reduce a dimension for the first plurality of through-slots at the first openings;
a second plate with a second side;
a second plurality of through-slots in the second plate including respective second openings at the second side, wherein respective portions of the second side reduce a dimension for the second plurality of through-slots at the second openings; and,
a plurality of rollers for placement in the first and second plurality of through-slots, wherein the respective portions of the first side are for restraining the rollers in a first direction and wherein the respective portions of the second side are for restraining the rollers in a second direction, opposite the first direction.

2. The pendulum of claim 1 wherein the first and second pluralities of through-slots include respective radially outward sides and wherein the respective first and second portions form a portion of the radially outward sides.

3. The pendulum of claim 1 wherein the first and second pluralities of through-slots include respective radially inward sides and wherein the respective first and second portions extend from the radially inward sides.

4. The pendulum of claim 1 wherein the first and second pluralities of through-slots include respective radially outward and inward sides and wherein the respective first and second portions form a portion of the radially outward and inward sides.

5. The pendulum of claim 1 wherein the first and second pluralities of through-slots include respective radially inward sides and wherein the respective first and second portions extend from the radially inward sides.

6. A damper, comprising:
a flange plate with a plurality of fastener openings and a plurality of roller openings;
a first pendulum plate with a first side and a first plurality of through-slots with respective first ends reduced in size by respective first portions of the first side;
a second pendulum plate with a second side and a second plurality of through-slots with respective second ends reduced in size by respective second portions of the second side;
a plurality of fasteners fixedly connecting the first and second pendulum plates and passing through the plurality of fastener openings; and,
a plurality of rollers disposed in the plurality of roller openings and in the first and second pluralities of openings, wherein the respective first portions are for restraining the rollers in a first axial direction and wherein the respective second portions are for restraining the rollers in a second axial direction, opposite the first axial direction.

7. The damper of claim 6 wherein the first and second pluralities of through-slots include respective radially outward sides and wherein the respective first and second portions form respective portions of the radially outward sides.

8. The damper of claim 7 wherein the respective first and second portions include radial protrusions extending from only part of the radially outward sides.

9. The damper of claim 6 wherein the first and second pluralities of through-slots include respective radially inward sides and wherein the respective first and second portions form respective portions of the radially inward sides.

10. The pendulum of claim 6 wherein the first and second pluralities of through-slots include respective radially outward and inward sides and wherein the respective first and second portions form a portion of the radially outward and inward sides.

11. The damper of claim 10 wherein the respective first and second portions include lips along the radially outward and inward sides.

12. The pendulum of claim 6 wherein the plurality of rollers include respective first and second axial ends and wherein the respective first portions are for restraining the rollers in a first axial direction by contacting the respective first axial ends and wherein the respective second portions are for restraining the rollers in a second axial direction by contacting the respective second axial ends.

13. A damper, comprising:
a flange plate with a first plurality of openings;
a first pendulum plate disposed on one side of the flange plate and with a second plurality of openings and a first radial wall facing a first axial direction;
a second pendulum plate disposed on another side of the flange plate and with a third plurality of openings and a second radial wall facing a second axial direction opposite the first axial direction;
a plurality of fasteners connecting the first and second pendulum plates and with respective first and second longitudinal ends; and,
a plurality of rollers disposed in the first, second and third pluralities of openings, wherein the respective first and second longitudinal ends are radially aligned with the first and second radial walls or axially between the first and second radial walls.

14. The pendulum of claim 13 wherein the first pendulum plate includes a first plurality of through-openings with a first segment having a first diameter and with a second segment, at the first radial wall, having a second diameter greater than the first diameter and wherein the second pendulum plate includes a second plurality of through-openings with a third segment having a third diameter and with a fourth segment, at the second radial wall, having a fourth diameter greater than the third diameter.

15. A method for dampening vibration, comprising:
passing a plurality of fasteners through respective fastener slots in a flange plate for a damper;
disposing a plurality of rollers in respective roller through-slots in the flange plate and in first and second pendulum plates;
fixedly connecting the first and second pendulum plates with the plurality of fasteners;
axially retaining the rollers with protrusions on the first and second pendulum plates extending across a portion of the respective roller through-slots for the first and second pendulum plates; and,
in response to rotation of the flange plate, displacing the first and second pendulum plates along a path prescribed by contact between the plurality of rollers and the flange plate and the first and second pendulum plates.

16. The method of claim 15 wherein the respective roller through-slots for the first and second pendulum plates include respective radially outward sides and wherein the protrusions on the first and second pendulum plates form respective portions of the radially outward sides.

17. The method of claim 15 wherein the respective roller through-slots for the first and second pendulum plates include respective radially inward sides and wherein the protrusions on the first and second pendulum plates form respective portions of the radially inward sides.

18. The method of claim 15 wherein the plurality of rollers include respective first and second axial ends and wherein axially retaining the rollers with protrusions includes restraining the rollers in a first axial direction by contacting the protrusions on the first pendulum plate with the respective first axial ends, and restraining the rollers in a second axial direction by contacting the protrusions on the second pendulum plate with the respective second axial ends.
